(19) United States
(12) Patent Application Publication
(10) Pub. No.: US 2014/0311691 A1
(43) Pub. Date: Oct. 23, 2014

(54) Retractable Golf Cart Windshield

(71) Applicant: Kevin Joseph Newell, Indianapolis, IN (US)

(72) Inventor: Kevin Joseph Newell, Indianapolis, IN (US)

(21) Appl. No.: 14/189,103

(22) Filed: Feb. 25, 2014

Related U.S. Application Data
(60) Provisional application No. 61/768,647, filed on Feb. 25, 2013.

(51) Int. Cl. B60J 1/04

(52) U.S. Cl. CPC B60J 1/04
USPC 160/323.1

(57) ABSTRACT

A retractable golf cart windshield includes a two piece case design that contains a roll-up plastic windshield. The user can pull the windshield down or roll it up much like a roll-up window shade. The present invention always keeps the windscreen under tension when in use as well as an optional lock/unlock characteristic that allows the end user to add or subtract tension. Another optional feature controls the return speed of the windscreen when it rolls up into the case. The case and roll-up screen cartridge can be supplied as an easily-installed replacement so that a user can easily replace a damaged windshield. The invention can be supplied as a kit.

This application is related to and claims priority from U.S. Provisional Patent application Ser. No. 61/768,647 filed Feb. 25, 2013. Application 61/768,647 is hereby incorporated by reference.

### BACKGROUND

1. Field of the Invention

The present invention relates generally to golf cart accessories and more particularly to a retractable golf cart windshield.

2. Description of the Prior Art

Numerous accessories for golf and golf carts are know in the art. Various wind screens and the like have been proposed to keep rain and wind out of a golf cart. In particular, it is known in the art to provide plastic curtains, hard sides and window frames and the like. However, these devices are cumbersome to deploy and take down. Curtains are subject to tearing and blowing.

What is badly needed is a retractable golf cart windshield that can roll up and pull down to provide protection from rain, sun and wind.

### SUMMARY OF THE INVENTION

The present invention relates to a retractable golf cart windshield that includes a two piece case design that contains a roll-up plastic windshield. The user can pull the windshield down or roll it up much like a roll-up window shade. The present invention always keeps the windscreen under tension when in use as well as an optional lock/unlock characteristic that allows the end user to add or subtract tension. Another optional feature controls the return speed of the windscreen when it rolls up into the case.

### DESCRIPTION OF THE FIGURES

Attention is directed at several drawings that illustrate features of the present invention.

FIG. 1 shows a perspective view of a screen.

FIG. 2 shows a perspective view of a case to hold the screen of FIG. 1.

FIG. 3 shows an end schematic view of the case of FIG. 2.

FIG. 4 shows a side schematic view of the case of FIG. 2.

FIG. 5 shows a perspective view of the screen on a roller.

FIG. 6 shows details of an embodiment of the present invention.

FIG. 7 shows end mounting details.

FIG. 8A shows fitting the present invention to a golf cart.

FIGS. 8B-8E show mounting details.

FIG. 9 shows items included when the present invention is supplied as a kit.

Several drawings and illustrations have been presented to aid in the understanding of the present invention. The scope of the present invention is not limited to what is shown in the figures.

### DESCRIPTION OF THE INVENTION

The present invention relates to a retractable golf cart windshield. The invention includes a plastic screen that rolls up in a two-piece aluminum (or any other material) case. The case protects the windscreen when it is not in use. The two-piece case of the preferred embodiment opens up after removing a screw from each side. This allows the front of the case to pivot upward and be removed. The user can then remove a screw and a fastener such as a cotter pin and swap out the windscreen cartridge assembly.

An embodiment of the case contains two linear grooves on the back of the extrusion. This allows the invention to utilize a plurality of different brackets and bracket configurations to adapt the device to different golf cart manufacturer's products. These grooves optionally can be used for the addition of various accessories such as a card holder, golf clubs, mirrors and advertising space inserts.

The present invention allows the user to easily replace the windshield cartridge. This provides ease in replacing a damaged windshield. A replacement cartridge can be supplied to users who simply wish a replacement.

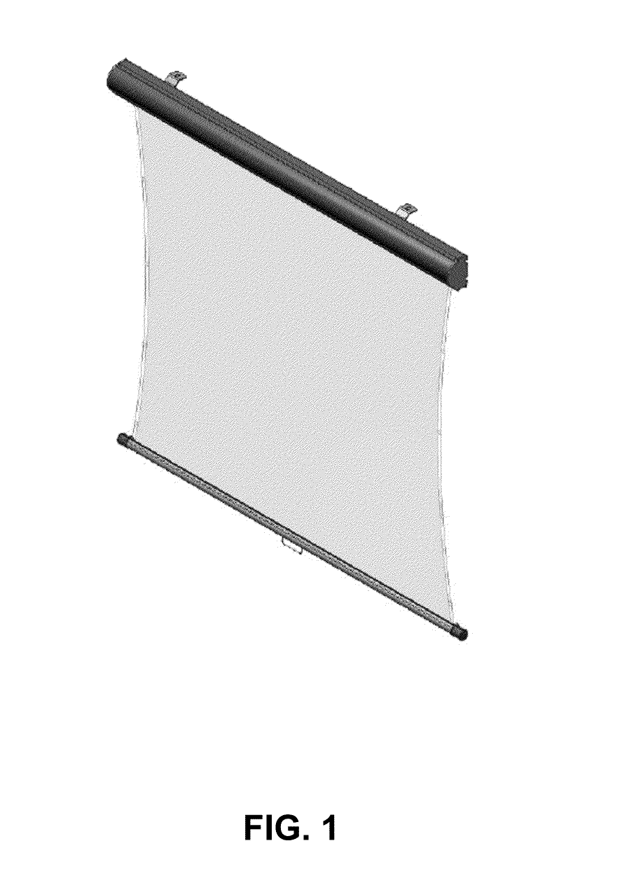

FIG. 1 shows a perspective view of an embodiment of a screen as used in the present invention. The screen should be made of any transparent material that can be rolled up. Transparent plastic is a preferred material.

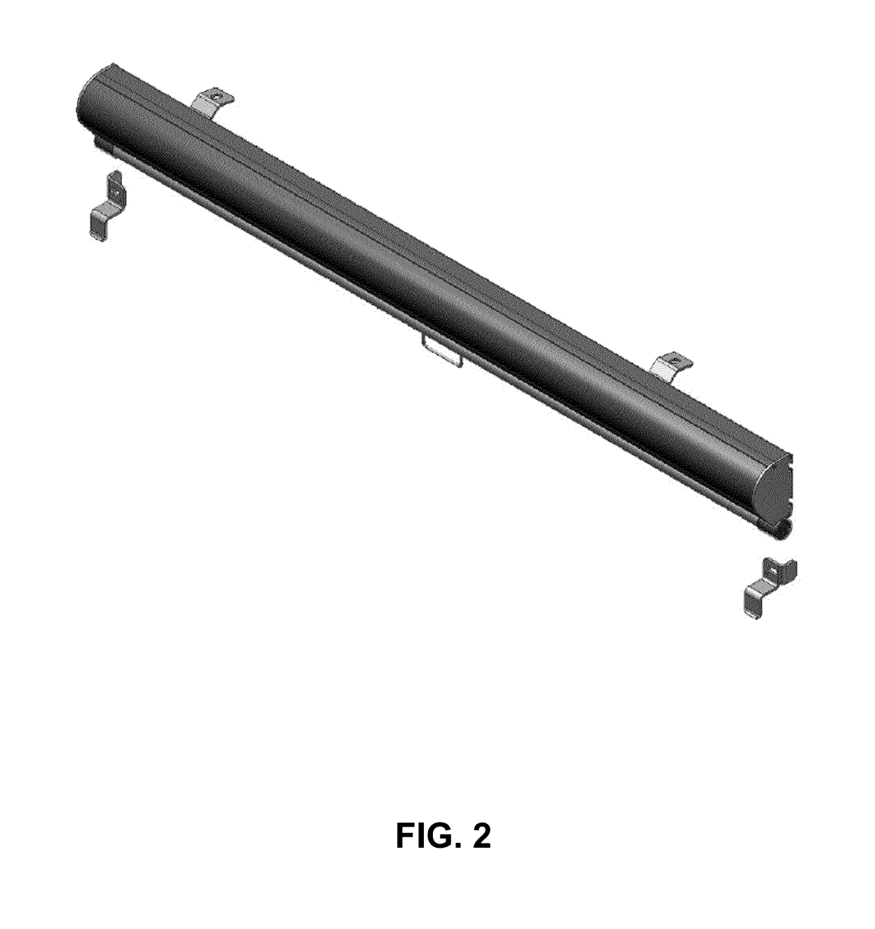

FIG. 2 shows a perspective view of an embodiment of a case that can hold the rolled up screen and that can attach to a golf cart. Attachment brackets can also be seen. A preferred material for the case is aluminum; however, any rigid material may be used including rigid plastics and other metals.

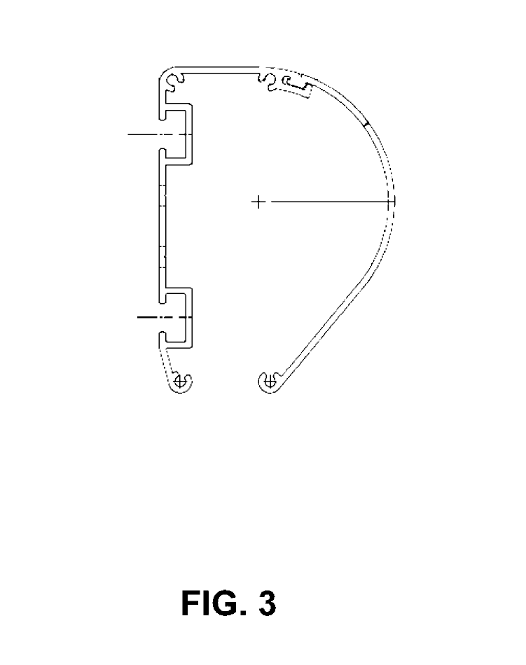

FIG. 3 shows an end schematic view of the case of FIG. 2. While FIG. 3 shows a particular shape, any cross-sectional shape is within the scope of the present invention. The case should be elongated and be able to hold a roller with the rolled up screen. A slot allows deployment of the screen. Tensioning devices and optional lock/unlock features may be employed in the case to control the deployment and roll-up of the screen.

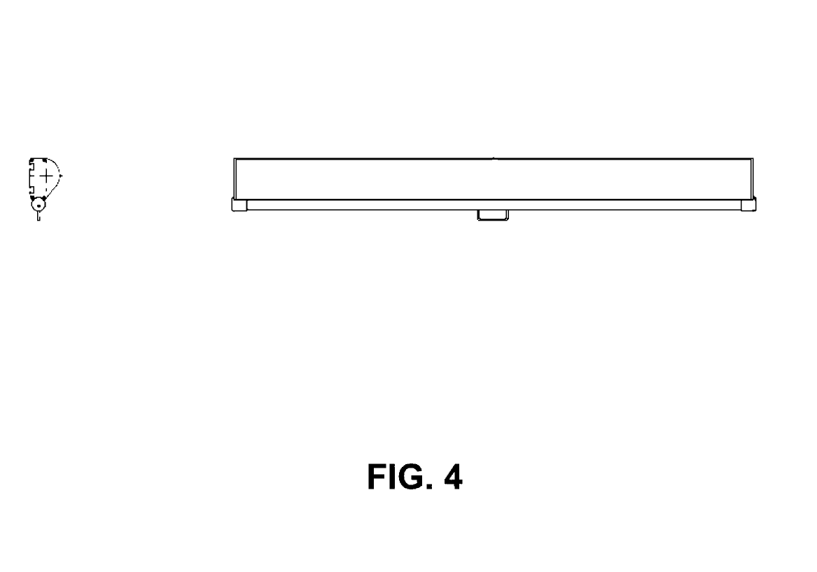

FIG. 4 shows a side schematic view of the case of FIGS. 2-3. The length of the case should be sufficient to extend across the top front of a golf cart. Different sizes and lengths of cases can be manufactured to match different manufacturer's golf carts. The case may be attached to the golf cart with any type of fastener. A preferred fastening method is to bolt the case to the cart; however, in alternative embodiments, adhesive, fasteners and any other fastening method or means may be used.

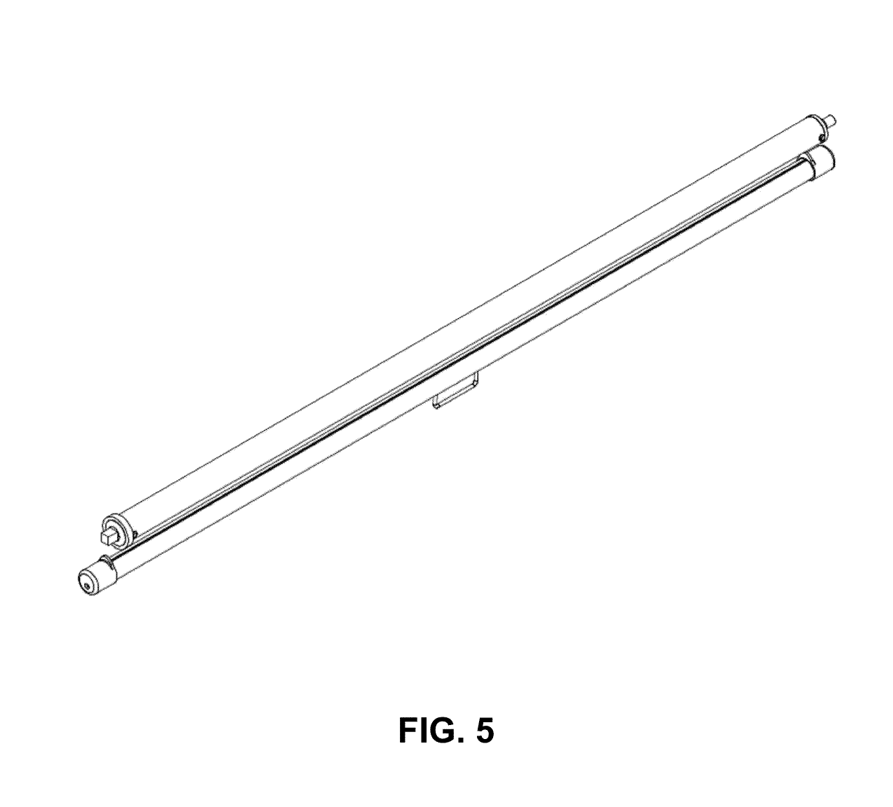

FIG. 5 shows a perspective view of a roller used to roll up the screen of FIG. 1. This roller should match the width of the screen and can contain end caps or other types of connections or inserts into the case. This roller should be free to rotate in the case; however, as previously described, optional tensioning and lock/unlock features may be included. The end connections of the roller should be spring loaded so that the spring increases in tension as the screen is deployed and decreases in tension as the screen is retracted. The springs pull the screen back into the case on the roller. Also, a slow return option may be advantageously employed to prevent the screen from rolling up too fast when released.

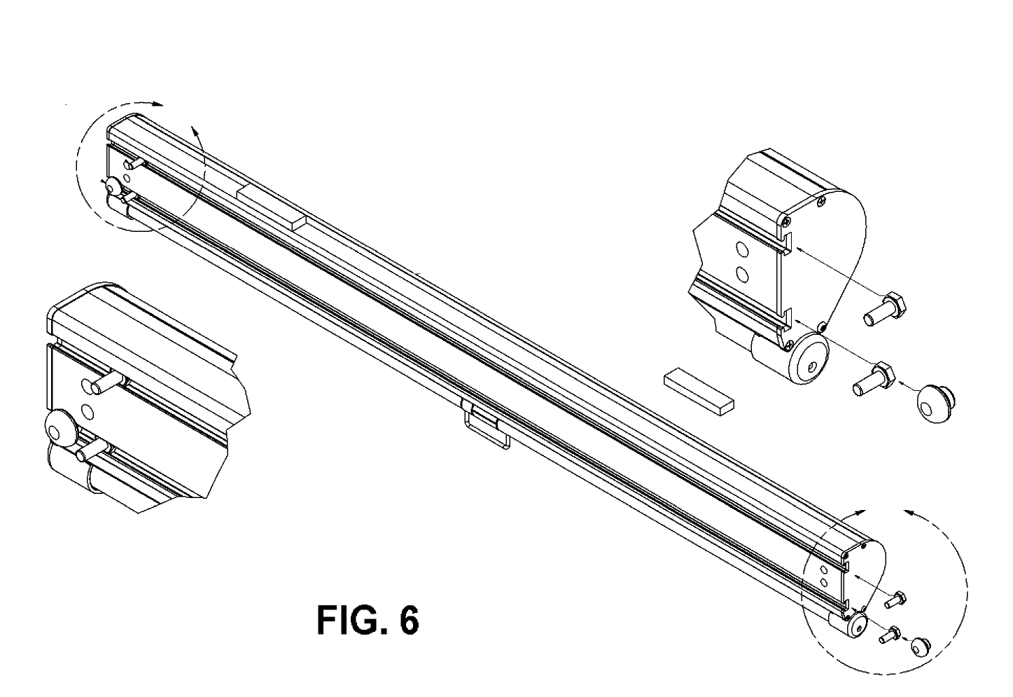

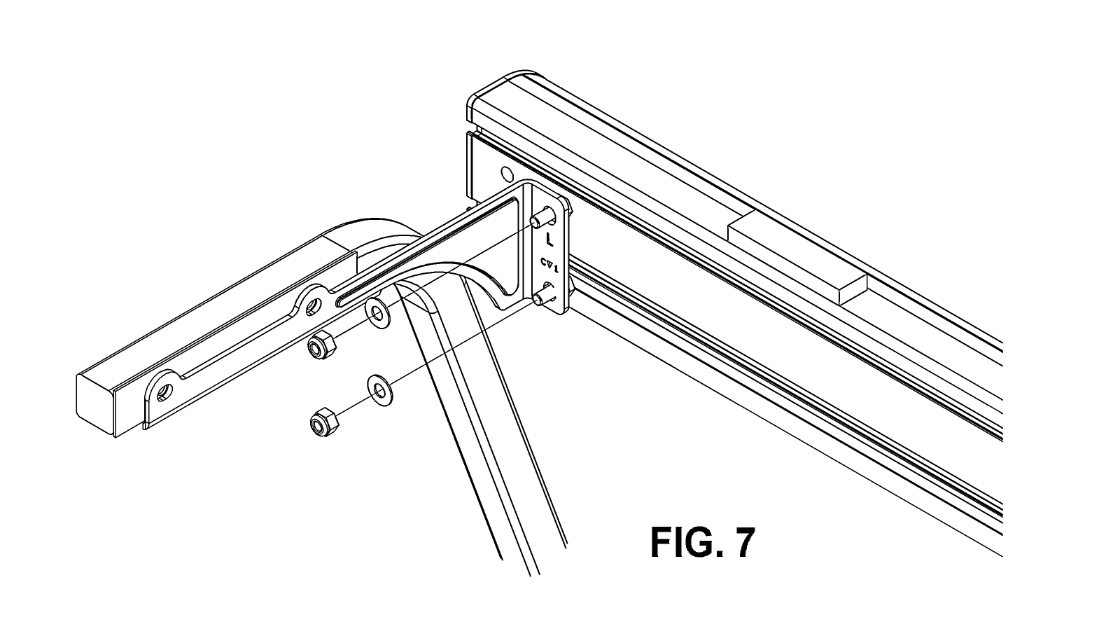

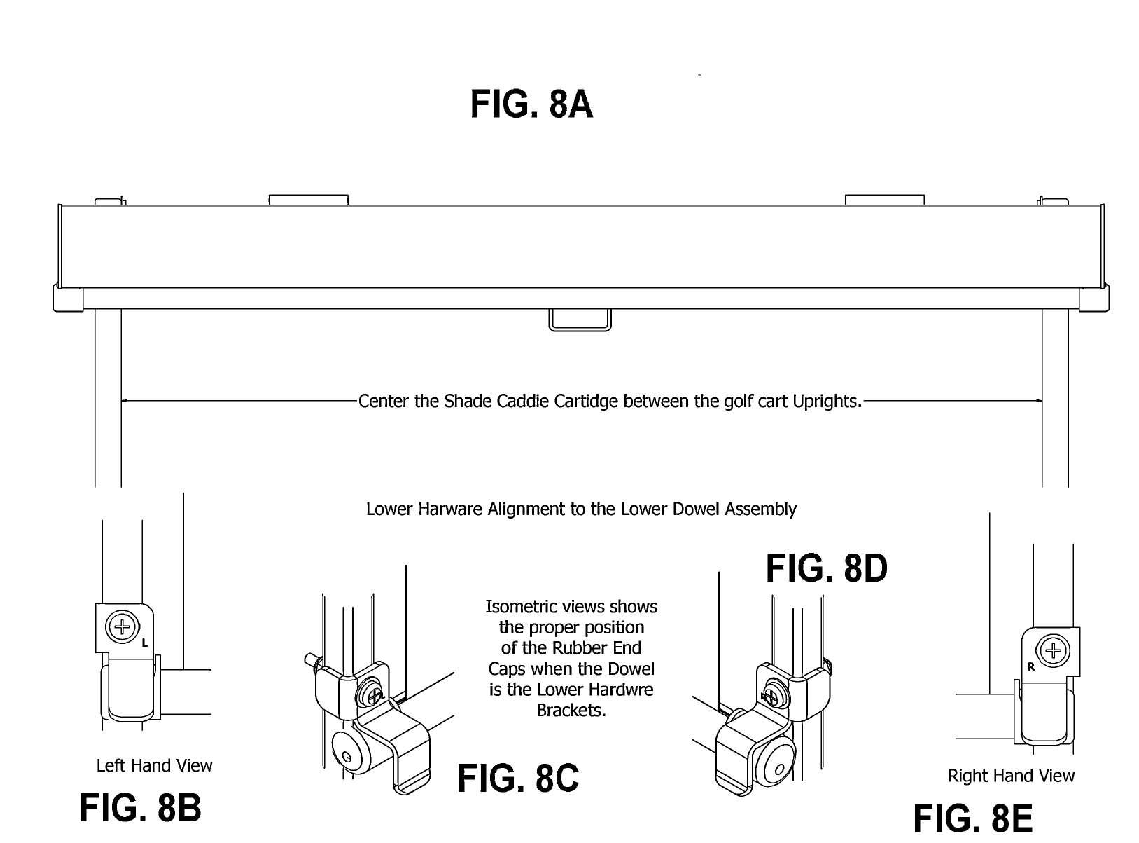

Embodiments of the present invention are easily installed on a golf cart as follows (FIGS. 6, 7, 8A-8E) from a supplied kit.
1. Prior to installation, remove any existing hardware from the golf cart uprights.
2. Attach the lower bracket hardware to the lower uprights on the golf cart.
3. The attachment method utilizes existing lower mounting holes designed for the windshield. In most cases this allows for no drilling required by the installer.
4. When tightening the lower hardware locking nuts, allow for some movement for final adjustment.
5. Attach upper brackets to the golf cart's roof support uprights. This typically uses the cart hardware designed to attach a roof.
6. Tighten the hardware, but allow some slight movement of the upper brackets for final adjustment.
7. Lift the cartridge up to the installation position between the uprights and under the molded golf cart roof.
8. Review the alignment and determine if any area of the molded roof comes in contact with the top of the cartridge. Align so there is no contact.
9. Attach foam isolation pads. Peel paper back from foam pads as they are installed.
10. Slide four bolts into the slide track system on the back of the cartridge.
11. Slide isolation pads into the two lower tracks of the cartridge (optional). Note: Apply pressure to the isolation bumper.
12. Lift the cartridge up to the installation position and align the bolts to the upper hardware bracket's mounting holes.
13. Center the cartridge between the golf cart uprights and the roof edge.
14. Add washers and locking nuts to the bolts and tighten. Allow a slight amount of movement for final adjustment.
15. Pull the windshield down and lock it into the lower mounted hardware brackets.

The present invention provides an easily installed windscreen for a golf cart that rolls up when not in use.

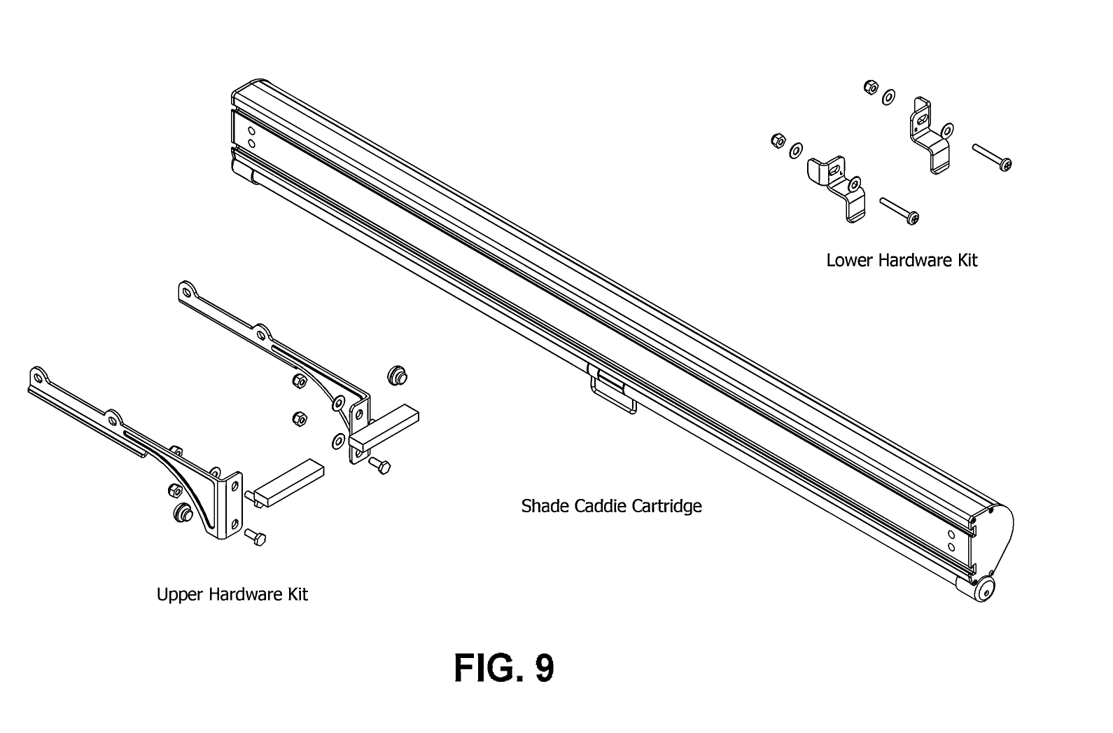

FIG. 9 shows items typically supplied in kit form to allow easy installation of the present invention.

It should be noted that in several of the drawings dimensions and/or tolerances have been provided. These are provided strictly as an example of a particular embodiment of the present invention. The scope of the present invention is not limited to any of the dimensions or tolerances given, and may in fact, be made with many different and various dimensions and tolerances.

Several descriptions and illustrations have been presented to aid in understanding the features of the present invention. One with skill in the art will realize that numerous changes and variations are possible without departing from the spirit of the invention. Each of these changes and variations is within the scope of the present invention.

I claim:

1. A retractable golf cart windshield comprising:
a roll-up transparent screen on a roller;
an elongated case adapted to hold said roll-up screen and roller;
wherein, said case is adapted to be attached to a golf cart so that said roll-up screen can act as a roll-up windshield when extended;
a tensioning device in said case adapted to keep said screen under tension when extended.

2. The retractable golf cart windshield of claim 1 further comprising a slow return option that controls return speed of said screen as it rolls up into said case.

3. The retractable golf cart windshield of claim 1 wherein said case is metal.

4. The retractable golf cart windshield of claim 3 wherein said metal is aluminum.

5. The retractable golf cart windshield of claim 1 wherein said case with said roll-up screen can be easily replaced as a unit.

6. A retractable golf cart windshield kit comprising:
a roll-up transparent screen on a roller;
an elongated case adapted to hold said roll-up screen and roller; said case configured to be attached to a golf cart so that said roll-up screen can act as a roll-up windshield when extended;
a tensioning device in said case adapted to keep said screen under tension when extended.
a plurality of mounting brackets adapted to allow mounting of said elongated case to an existing golf cart;

7. The retractable golf cart windshield kit of claim 6 further comprising a slow return option that controls return speed of said screen as it rolls up into said case.

8. The retractable golf cart windshield kit of claim 6 wherein said case is metal.

9. A retractable golf cart windshield comprising:
a roll-up transparent screen on a roller;
an elongated case adapted to hold said roll-up screen and roller;
wherein, said case is adapted to be attached to a golf cart so that said roll-up screen can act as a roll-up windshield when extended;
a tensioning device in said case adapted to keep said screen under tension when extended;
a slow return option that controls return speed of said screen as it rolls up into said case.

10. The retractable golf cart windshield kit of claim 9 wherein said case is metal.
